(19) United States
(12) Patent Application Publication
(10) Pub. No.: US 2021/0287252 A1
(43) Pub. Date: Sep. 16, 2021

(54) DYNAMIC VEHICLE ADVERTISEMENT

(71) Applicant: Sony Corporation, Tokyo (JP)

(72) Inventor: Bibhudendu Mohapatra, San Diego, CA (US)

(21) Appl. No.: 16/814,968

(22) Filed: Mar. 10, 2020

(51) Int. Cl. G06Q 30/02; G06K 9/00; G06F 16/903

(52) U.S. Cl. CPC G06Q 30/0265; G06F 16/90335; G06K 9/00791; G06Q 30/0242

(57) ABSTRACT

A vehicle includes a license plate frame. A processor is configured with instructions executable to present changing messages on the license plate frame. The processor may receive images of other vehicles and send a signal to a server pertaining the number of views of a message based on analysis of the images.

### FIELD

The application relates generally to advertisements on vehicles.

### BACKGROUND

As understood herein, vehicles are uniquely identified by registration numbers, an example of which may be a license plate number on a license plate, also referred to herein as a registration plate.

### SUMMARY

Present principles understand that as vehicles become more digitized and connected, the registration plates (license plate numbers) may become the center-point of vehicle-to-vehicle and vehicle-to-infrastructure communication as vehicle identifiers. Present principles provide for personalizing a license plate frame or other vehicle surface to enable companies/organizations to advertise, and to rid the vehicle of unnecessary stickers, etc. from the windshield and other surfaces of the vehicle.

Accordingly, present principles provide an assembly with at least one imager, at least one display that is some embodiments is implemented by a license plate frame, and at least one processor configured with instructions executable to present a first message on the display at a first time and replace the first message with a second message on the display at a second time. The instructions are executable to receive images from the imager, and to transmit a signal representing a number of views of the first message based at least in part on the images.

The first message may include an advertisement. In another example, the first message may include a parking permit.

In non-limiting implementations, the instructions can be executable to present on a user device a solicitation to present the first message on the display along with a selector selectable to accept or decline the solicitation. If desired, the instructions may be executable to present on a user device within a vehicle a field into which the first message can be entered using an input device.

The number of views of the first message may represent a number of vehicles within a first distance of the license plate frame and/or a number of vehicles imaged within a first time period.

In another aspect, a method includes presenting an advertisement on an electronic display of a license plate frame of a vehicle. The method further includes receiving a query related to the advertisement, responding to the query, and sending a signal to at least one server pertaining to at least the query. The method may if desired further include sending a signal to the server pertaining to a response to the query.

In another aspect, an assembly includes a vehicle, a display that may be on a license plate frame on the vehicle, and at least one processor configured with instructions executable to present changing messages on the display.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates an example assembly consistent with present principles;

FIG. 2 illustrates an example vehicle consistent with present principles;

FIG. 3 illustrates an example CE device that may be used in conjunction with present principles;

FIG. 4 illustrates a block diagram of certain components of the vehicle and/or CE device shown in respective FIGS. 2 and 3;

FIGS. 5-9 illustrate examples of a changeable license plate frame consistent with present principles;

FIG. 10 illustrates in example flow chart form example logic consistent with present principles; and

FIG. 11 illustrates an example of a changeable license plate frame consistent with present principles.

### DETAILED DESCRIPTION

In overview, license plate frames typically hold license plates (with registration or license numbers) and may contain a permanent advertisement (such as for a dealer) or other message. Present principles allow the advertisements to be digitally controlled rather than embedded permanently. If a car owner wants to display a symbol or message which is unique, the owner may pay a certain amount of money to the person/organization which owns the message/organization. Similarly, if a company wants to show an advertisement on a registration plate, the company may pay a certain amount to the car owner using a registration number as the account number. Furthermore, depending on the number of people that view the advertisement, the car owner may be entitled to remuneration such as one dollar per thousand impressions. A variety of methods can be used for detecting an impression or likely impression. For instance, with an ad being displayed on a vehicle, it may be determined using computer vision analyzing images from a camera on the vehicle that a certain number of vehicles were behind the advertising vehicle at different times during the day approximately 3-5 meters away, and then it may be inferred that the drivers viewed the advertisement. Such viewers further may contact the advertising vehicle for more information about the advertised product using vehicle to vehicle communication, translating into revenue for the vehicle owner and the advertising entity. Windows and other parts of the car may be used for advertisement as well and connected with the user's registration plate for payment purpose.

Further, stickers such as parking related permits can become digital and associated with registration plate and change what they show based on GPS information. This can eliminate permanent parking permits.

In addition to license plate frames, advertisements, parking permits, and the like may be displayed on other vehicle surfaces and keyed in general to a vehicle identifier such as a license plate number, vehicle identification number (VIN), etc. that substantially uniquely identify the vehicle. Instead of a visible license plate, a vehicle may emit a wireless beacon with an identifier uniquely identifying the vehicle. As vehicle to vehicle and vehicle to infrastructure progresses, a roadside vendor or nearby vehicle may send a message to the vehicle after identifying the identifier in the beacon, which can betide to a network address. The message may contain offers or even inform the occupants of a vehicle that, for instance, a fast food order is ready for pick-up. Or, computer vision might be used on a physical license plate to enable a vendor to send targeted ads/offers to a vehicle as it passes by the vendor's store.

This disclosure relates generally to computer ecosystems including aspects of consumer electronics (CE) device networks such as but not limited to smart glasses and smart (computerized) vehicles. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

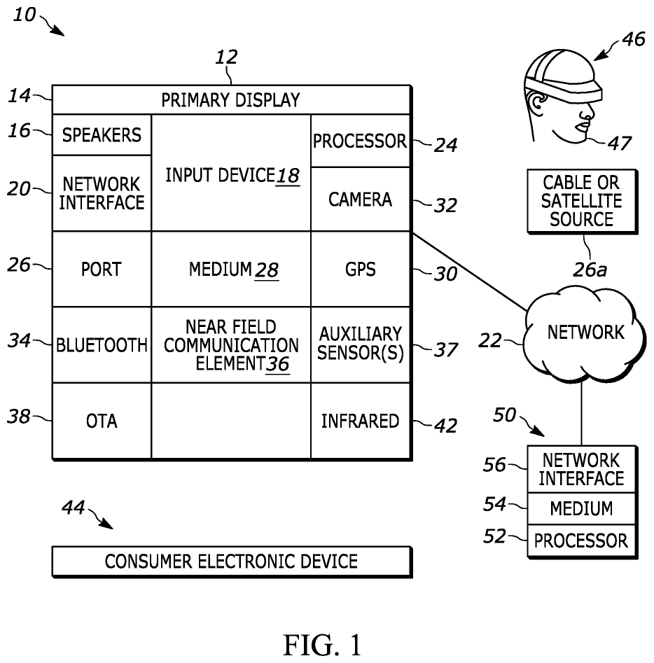

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or, the source 26a may be a game console or disk player containing content. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12.

Still referring to FIG. 1, in addition to the AVD 12, the system 10 may include one or more other CE device types. In one example, a first CE device 44 may be included in or integrated with a vehicle while a second CE device 46 may be implemented as head-mounted viewing device such as smart glasses. All devices in FIG. 1 may communicate with each other. A computerized device herein may implement some or all of the components shown for the AVD 12. Any of the components shown in the following figures may incorporate some or all of the components shown in the case of the AVD 12.

Now in reference to the afore-mentioned at least one server 50, it includes at least one server processor 52, at least one tangible computer readable storage medium 54 such as disk-based or solid state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm”, and may include and perform “cloud” functions such that the devices of the system 10 may access a “cloud” environment via the server 50 in example embodiments for, e.g., network gaming applications. Or, the server 50 may be implemented by one or more game consoles or other computers in the same room as the other devices shown in FIG. 1 or nearby.

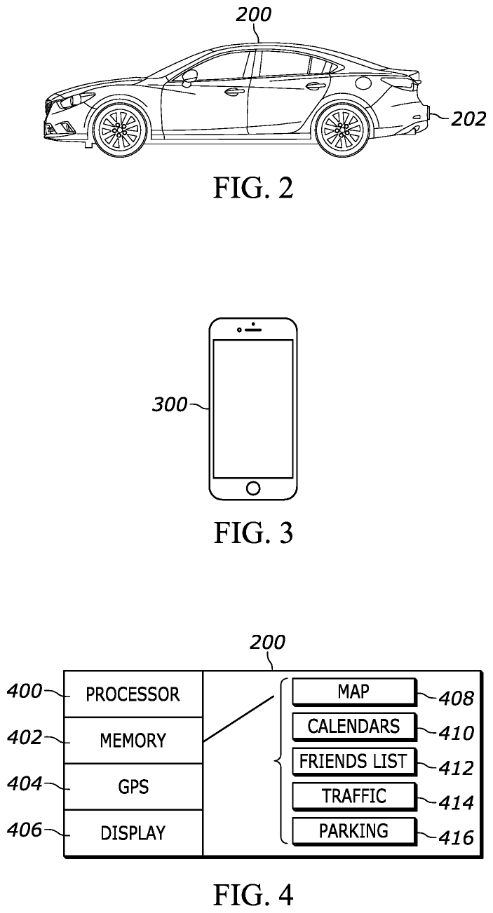

FIG. 2 illustrates a vehicle 200 that may include one or more of the components described herein to execute present principles. The vehicle 200 may include a rear and sometimes a front registration or license plate 202.

FIG. 3 illustrates a CE device 300 such as a smart phone that may be used in connection with present principles.

FIG. 4 illustrates that the vehicle 200 may include (either integrated within the vehicle or as part of a CE device being carried in the vehicle) one or more processors 400 accessing instructions and data on one or more computer memories 402. The processor 400 may receive location information from a location sensor such as a GPS sensor 404. The processor 400 may output information on one or more audible and/or visual displays 406.

The memory 402 may store map information 408 as received from a map server, calendar information 410 as received from user's mobile or other computing device, a friend's list 412 as received from a social network site, traffic information 414 as may be received from a traffic server, and parking information 416.

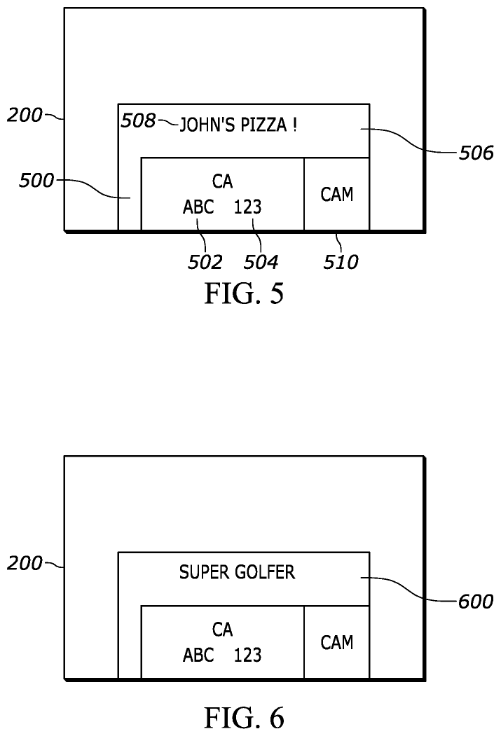

FIG. 5 illustrates a rear end view of the vehicle 200 in which a license plate frame 500 is configured to surround and in some embodiments support a vehicle license plate 502 bearing an alpha-numeric license number 504. The license plate frame 502 may be integral with the license plate 502 if desired or may be a separate piece of manufacture from the license plate. The license plate frame 500 may border at least one and typically borders plural edges of the license plate 502.

An electronic display 506 is provided on the license plate frame 500. In the example shown in FIG. 1, a first message 508, in this case, an advertisement, is presented on the display 506. The display 506 is controlled by a processor such as any described herein that may be part of the vehicle 200, e.g., an engine control module (ECM) or other processor, or that may be a processor of a CE device that can be carried within the vehicle and that can wirelessly communicate with the display 506.

The processor may receive images from a camera 510 such as any of the cameras described herein. In the example shown, the camera 510 is mounted on the vehicle 200 adjacent the license plate frame 500 just to the side of the license plate 502.

FIG. 6 illustrates that the processor may replace the first message 508 in FIG. 5 with a second message 600, in this case a custom-entered message about the vehicle driver.

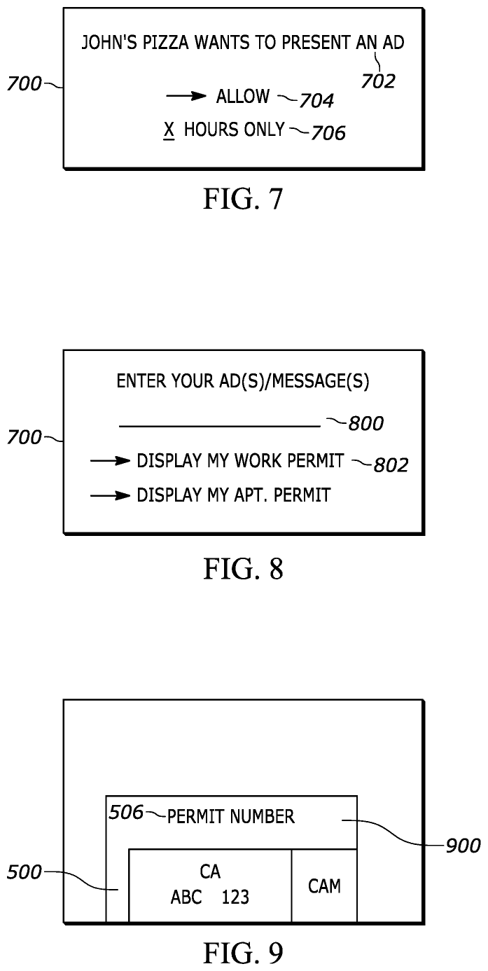

FIG. 7 illustrates a user display 700 which may be implemented by any display herein, such as a display of the CE device 44. The display 700 may receive a solicitation 702 to present an advertisement on the license plate frame 500. The solicitation may be addressed to the license plate number 504, which can be correlated in an online database with the network address of the device associated with the display 700 to which the solicitation is sent.

A selector 704 may be presented to allow presentation of the solicited advertisement. A field 706 also may be presented to enter a time period for which the advertisement is to be presented on the license plate frame 500.

FIG. 8 illustrates that the display 700 may be used to enter into a field 800 a custom message such as the message 600 illustrated in FIG. 6. Moreover, parking permit selectors 802 may be presented and may be selectable to change the message presented on the license plate frame 500 to parking permit numbers for, e.g., home and work, to dispense with the need for parking stickers. FIG. 9 illustrates such a parking number being presented on the display 506 of the license plate frame 500.

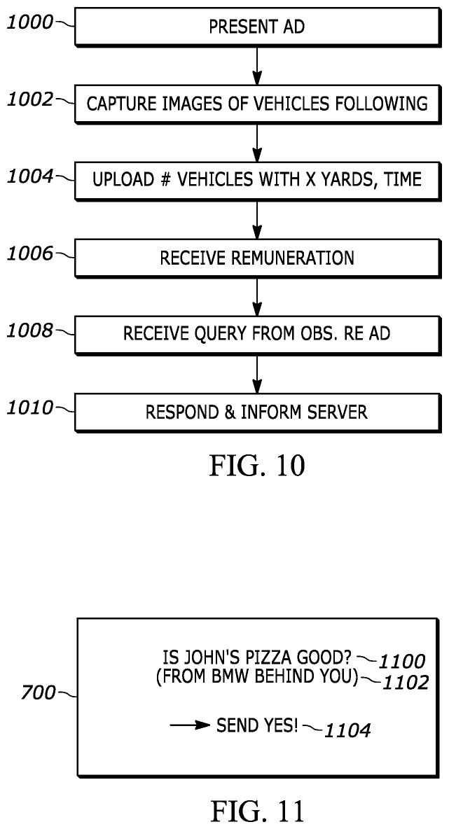

Refer now to FIG. 10 for example logic that the above-described processor may execute. Commencing at block 1000, an advertisement may be presented on the display 506 of the license plate frame 500. Moving to block 1002, as the ad is displayed, images from the camera 510 in FIG. 5 are received. The images are of the area in line of sight of the license plate frame 500. The processor can execute image recognition on the images to determine an estimate of a number of views of the ad being presented. For example, based on the size of an image of an object identified using image recognition as a following vehicle, the processor can determine an approximate distance the following vehicle was to the license plate frame, and can increment a count of a number of views of the ad if the distance is within a threshold, e.g., within five or ten meters of the camera (and, hence, of the ad next to the camera). The processor also may count only views in a threshold period, e.g., the period during which the ad was displayed. This information may be uploaded wireless to a server associated with the ad at block 1004.

Block 1006 indicates that an owner of the vehicle 200 may be rewarded with remuneration based on the number of views of the ad. Similarly, the owner of the vehicle may pay remuneration to another entity for the privilege of presenting a particular message.

Further, block 1008 indicates that a query may be received from a following vehicle pertaining to the ad. The query may be addressed to the license plate number 504 similar to how the solicitation described previously is delivered. Or, given that the query may come from a nearby vehicle whose occupant is viewing the ad, the query (and response) may be effected using localized point-to-point communications such as Bluetooth®. Briefly referring to FIG. 11, a query 1100 is presented on the display 700, along with, if desired, an identification 1102 of the querying vehicle. A selector 1104 may be provided and may be selectable to respond to the query.

Block 1010 indicates that the response is sent to the querying vehicle and a message sent to a network server pertaining to the query and/or to the response to the query. The owner of the vehicle may be remunerated by the advertiser based on the query and/or response.

It will be appreciated that whilst present principals have been described with reference to some example embodiments, these are not intended to be limiting, and that various alternative arrangements may be used to implement the subject matter claimed herein.

What is claimed is:

1. An assembly comprising:
at least one imager;
at least one display on a vehicle;
at least one processor configured with instructions executable to:
to present a first message on the display at a first time and replace the first message with a second message on the display at a second time;
receive images from the imager; and
transmit a signal representing a number of views of the first message based at least in part on the images.

2. The assembly of claim 1, wherein the first message comprises an advertisement.

3. The assembly of claim 1, wherein the first message comprises a parking permit.

4. The assembly of claim 1, wherein the instructions are executable to:
present on a user device a solicitation to present the first message on the display along with a selector selectable to accept or decline the solicitation.

5. The assembly of claim 1, wherein the instructions are executable to:
present on a user device within a vehicle a field into which the first message can be entered using an input device.

6. The assembly of claim 1, wherein the number of views of the first message represent a number of vehicles within a first distance of the license plate frame.

7. The assembly of claim 1, wherein the number of views of the first message represent a number of vehicles imaged within a first time period.

8. The assembly of claim 6, wherein the number of views of the first message represent a number of vehicles imaged within a first time period.

9. A method, comprising:
presenting an advertisement on an electronic display of a vehicle;
receiving a query related to the advertisement;
responding to the query; and
sending a signal to at least one server pertaining to at least the query.

10. The method of claim 9, comprising:
sending a signal to the server pertaining to a response to the query.

11. The method of claim 9, comprising:
transmitting a signal representing a number of views of the advertisement.

12. The method of claim 9, comprising:
presenting on a user device a solicitation to present the advertisement along with a selector selectable to accept or decline the solicitation.

13. The method of claim 11, comprising:
identifying the number of views by identifying a number of vehicles within a first distance of the display, the display being implemented on a license plate frame.

14. The method of claim 11, wherein the number of views represents a number of vehicles imaged within a first time period.

15. An assembly, comprising:
a vehicle;
a license plate frame on the vehicle; and
at least one processor configured with instructions executable to present changing messages on the license plate frame.

16. The assembly of claim 15, instructions executable to:
present a first message on the display at a first time and replace the first message with a second message on the display at a second time.

17. The assembly of claim 15, instructions executable to:
receive images from an imager; and
transmit a signal representing a number of views of a message based at least in part on the images.

18. The assembly of claim 17, wherein the number of views represents a number of vehicles within a first distance of the license plate frame.

19. The assembly of claim 17, wherein the number of views represents a number of vehicles imaged within a first time period.

20. The assembly of claim 18, wherein the number of views represents a number of vehicles imaged within a first time period.
